(19) United States
(12) Patent Application Publication
(10) Pub. No.: US 2006/0293929 A1
(43) Pub. Date: Dec. 28, 2006

(54) Electronic-ticket service system based on color-scale-code image recognition

(75) Inventors: Quen-Zong Wu, Taoyuan (TW); Yuang-Tzong Lan, Taoyuan (TW)

Correspondence Address: HDSL, 4331 STEVENS BATTLE LANE, FAIRFAX, VA, 22033, US

(73) Assignee: Chunghwa Telecom co., Ltd.

(21) Appl. No.: 11/159,166

(22) Filed: Jun. 23, 2005

(51) Int. Cl. G06Q 10/00; G01C 21/34; G01C 21/36

(52) U.S. Cl. 705/5; 705/6

(57) ABSTRACT

An electronic ticket service system based on color scale image recognition for individual identification, purchasing certificate or bill payment. Different from the conventional black-and-white one- or two-dimensional barcode, the color scale uses assembly of color scales for various colors. Each assembly of multiple color scales represents one element, such that the information capacity is greatly increased. The user can order the ticket via phone or internet. When the user has successfully input the purchase information and complete the payment procedure, the electronic ticket service center can issue and transmit the electronic ticket containing the color scale code to the assigned device through multimedia or wireless transmission. The assigned device can be cellular phones or other mobile communication terminal devices. Upon entrance, the electronic ticket displayed by the cellular phones or the mobile communication terminals is verified by a ticket verification device.

### BACKGROUND OF THE INVENTION

The present invention relates in general to an electronic-ticket service system based on color-scale-code image recognition, and more particularly, to an electronic ticket based on color-scale-code image recognition displayed on a mobile communication terminal as an individual identification, purchase certificate or bill payment.

Currently, the electronic ticket is typically in the form of one- or two-dimensional black-and-white bar codes. Being limited by the display screen of a mobile communication device, the displayed information is very limited.

### BRIEF SUMMARY OF THE INVENTION

An electronic-ticket service system based on color-scale-code image recognition is provided. With the same display cost, more information can be displayed to provide more accurate verification and identification.

The electronic ticket is formed of color scale codes. When the user completes the purchase procedure, the electronic ticket is encoded with a color scale code and transmitted to the terminal assigned by the purchaser. The electronic ticket is transmitted via multimedia or wireless transmission, and the terminal includes cellular phones or other mobile communication devices. The system provides a ticket verification device based having an image recognition kernel to verify the color scale code displayed by the cellular phones or mobile communication devices.

### BRIEF DESCRIPTION OF THE DRAWINGS

The above objects and advantages of the present invention will be become more apparent by describing in detail exemplary embodiments thereof with reference to the attached drawings in which:

FIG. 1 shows an electronic-ticket service system based on color scale image recognition;

FIG. 2 shows a first embodiment of a color scale code;

FIG. 3 shows a second embodiment of a color scale code;

FIG. 4 shows a third embodiment of a color scale code; and

FIG. 5 shows a fourth embodiment of a color scale code.

### DETAILED DESCRIPTION OF THE INVENTION

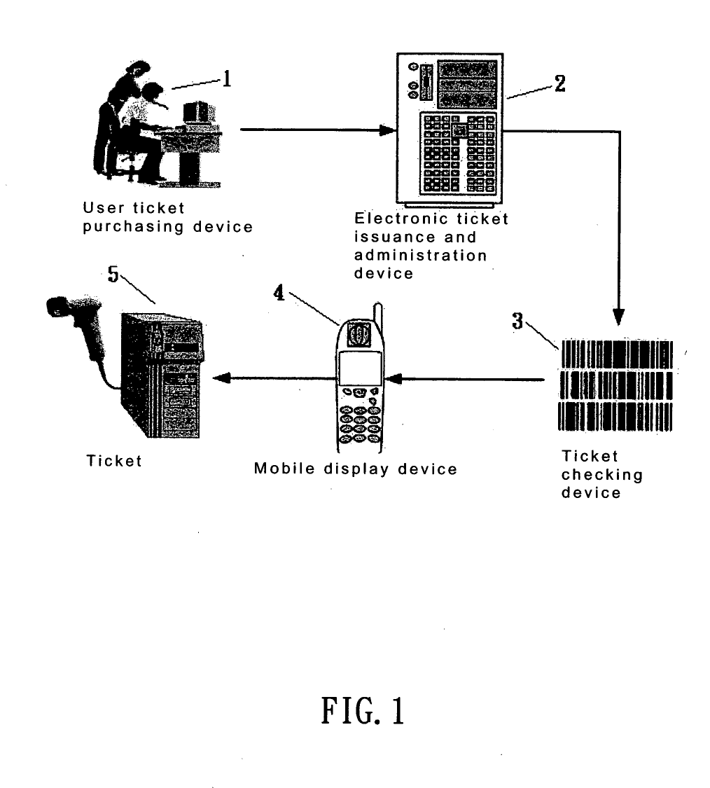

Referring to FIG. 1, an electronic-ticket service system based on color-scale-code image recognition is provided. The system includes a purchasing device 1, an issuance and management device 2, a mobile display device 4, and a ticket verification device 5. The purchasing device 1 allows the user to purchase and pay for an electronic ticket 3. The issuance and management device 2 issues and encodes the electronic ticket 3, so as to generate the color scale code 6 in the electronic ticket 3. The issuance and management device 2 also transmits the electronic ticket 3 to the mobile display device 4 via wireless transmission. When the electronic ticket 3 is received, the electronic ticket 3 can be displayed on the screen of the mobile display device 4. The verification device 5 can then decode the color scale code 6 displayed on the mobile display device 4, so to verify the correctness of the electronic ticket 33.

The user can purchase the electronic ticket via phone, internet or other communication media. When the user complete the purchase and payment procedure, the issuance and management device 2 encode the electronic ticket 33 according to the purchase information provided by the user. The electronic ticket 33 may includes information such as the number of the mobile display device 4 like a cellular phone, the date, program information, seat information or other important information. The electronic ticket 3 formed of the color scale code 6 is transmitted to the mobile display device 4 through multimedia or other wireless transmission device. Upon entrance of the event, the color scale code 6 of the electronic ticket 33 is displayed on the mobile display device 4 and verified by the ticket verification device 5. The ticket verification device 5 is operative to decode and recognize the color scale code 6 displayed on the mobile display device 4. If the automatic recognition result of the ticket verification device 5 appears unreasonable or faulty, the system manager can input the correct result manually. The ticket verification device can determine whether the electronic ticket 3 is valid or not based on the issuance information of the electronic-ticket system.

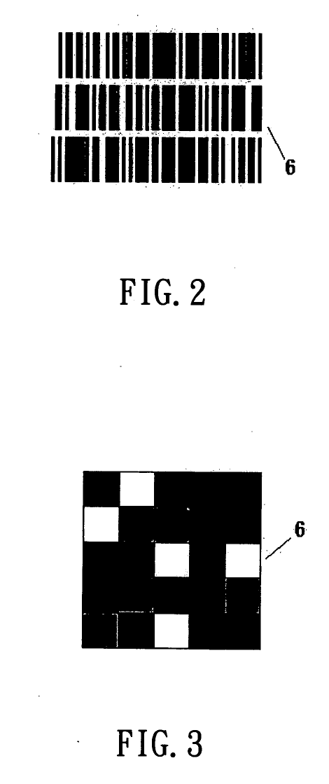

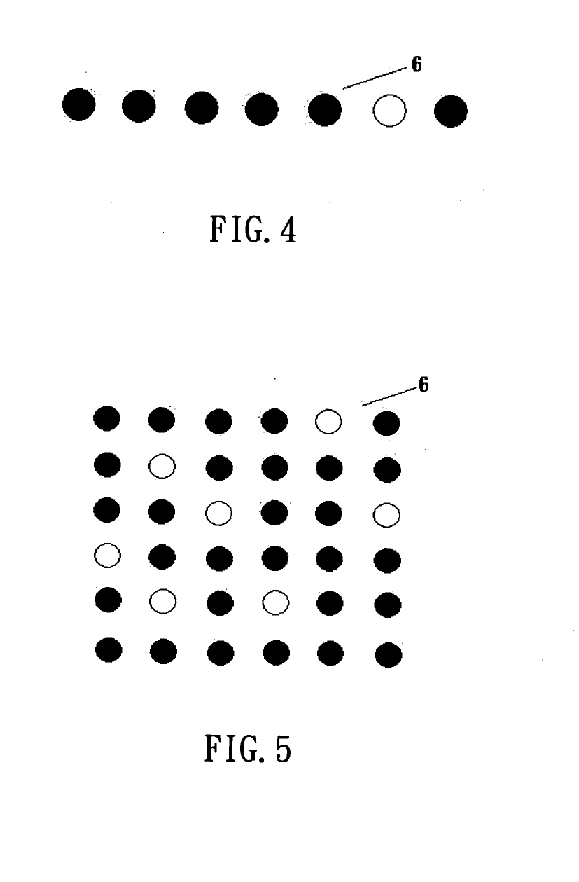

FIGS. 2 to 5 show various embodiments of color scale codes 6. Different from the one- or two-dimensional black-and-white bar codes, the color scale code 6 adapts all the color scales including black and white to represent one element. The more color scales are adapted in each electronic ticket 3, the more information can be stored and represented thereby. Consequently, the image recognition technique of the color scale code 6 is more difficult. The traditional one- or two-dimensional barcodes can all be replaced by the color scale code 6 to accommodate more information. In one embodiment, the color scale code 6 adapts red, green, blue, black and white to represent each bit. That is, each bit can be red, green, blue, black or white color. The conventional binary one- and two-dimensional black-and-white barcode is thus replaced by a quinary color scale code that has more information capacity. In addition, as the color scale is displayed on the mobile display device 4, the paper and ink for printing the color scale code is not required.

The electronic ticket service system based on the color scale code image recognition thus has the following advantages.

As the color scale code 6 of the electronic ticket 3 is displayed on the mobile display device 4, the paper or ink required by the conventional barcode is not required. Therefore, the cost is greatly reduced.

Being combined with the image recognition technology, the color scale code can be stored in the mobile communication device such as cellular phones.

By the application of the above activation medium 2, the activation mechanism of a personal financial activity can be achieved as follows.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. An electronic-ticket service system based on color-scale-code image recognition, comprising:
at least one purchasing device, allowing a user to input purchasing and payment information;
at least one issuance and management device, to encode an electronic ticket with a color scale code in accordance with the purchasing and payment information input by the user, and to transmit the electronic ticket;
at least one mobile display device, operative to receive and display the electronic ticket transmitted by the issuance and management device; and
at least one ticket verification device, to verify the color scale code encoded in the electronic ticket displayed by the mobile display device.

2. The system of claim 1, wherein the color scale code is formed of red, green, blue, black and white color scales.

3. The system of claim 1, wherein the color scale code is formed of a plurality of color scales.

4. The system of claim 1, wherein the color scale code includes an arbitrary pattern constructed by a plurality of color scales.

5. The system of claim 1, wherein the issuance and management device is operative to transmit the electronic ticket to any display device assigned by the user.

6. The system of claim 1, wherein the mobile display device includes a cellular phone.

7. The system of claim 1, wherein the mobile display device includes a mobile communication terminal.

8. The system of claim 1, wherein the ticket verification device includes an image processing mechanism to automatically decode the color scale code displayed by the mobile display device.

9. The system of claim 8, wherein the ticket verification device further comprises a verification unit to verify correctness of the color scale code displayed by the mobile display device.

10. The system of claim 8, further comprising a manual input device for inputting correct result when the image processing unit of the verification device is inoperative to read the color scale code.

11. An electronic ticket issuance and verification method, comprising:
inputting purchasing and payment information of an electronic ticket;
encoding the electronic ticket with a color scale code representing the purchasing and payment information;
transmitting the electronic ticket to an assigned mobile display device; and
verifying the color scale code of the electronic ticket.

12. The method of claim 11, further comprising generating the color scale code by a plurality of color scales.

13. The method of claim 12, wherein the color scales include red color scale, green color scale, blue color scale, black color scale and white color scale.
